(19) United States
(12) Patent Application Publication
(10) Pub. No.: US 2019/0359878 A1
(43) Pub. Date: Nov. 28, 2019

(54) ADDITIVES USEFUL FOR DRILLING FLUIDS

(71) Applicant: Baker Hughes, a GE company, LLC, Houston, TX (US)

(72) Inventors: Erna Kakadjian, The Woodlands, TX (US); Prahlad Yadav, Dist-Jabalpur (IN); Dennis Clapper, Houston, TX (US); Michael Teutsch, Houston, TX (US)

(73) Assignee: Baker Hughes, a GE company, LLC, Houston, TX (US)

(21) Appl. No.: 16/415,937

(22) Filed: May 17, 2019

Related U.S. Application Data
(60) Provisional application No. 62/675,029, filed on May 22, 2018.

(51) Int. Cl. C09K 8/36

(52) U.S. Cl. CPC C09K 8/36

(57) ABSTRACT

Methods and formulations useful for controlling and optimizing the rheological properties of invert emulsion (water-in-oil) drilling fluids at low and high temperatures, wherein an additive is incorporated into an invert emulsion drilling fluid, the additive being made up of at least one organophilic clay, at least one weighting agent, at least one emulsifier, at least one filtration control agent, at least one polyamide resin, and at least one ethoxylated alcohol-based or an ether carboxylic acid-based rheology modifier.

### CROSS-REFERENCE TO RELATED APPLICATION

This application claims the benefit of Provisional Patent Application No. 62/675,029 filed May 22, 2018, which is incorporated by reference herein in its entirety.

### TECHNICAL FIELD

The present invention relates to additives useful for controlling and improving the rheological properties of invert emulsion (water-in-oil) drilling fluids at low and high temperatures.

### BACKGROUND

In the exploration for oil, drilling fluids (also known as drilling muds) are generally used to serve certain functions such as lifting the cuttings to the earth's surface, lubricating and cooling the drill bit, maintaining the downhole pressure, etc. There are two major classes of these fluids: aqueous-based and non-aqueous-based. Non-aqueous based drilling fluids are also as well invert emulsion (water-in-oil) drilling fluids, in which diesel, mineral oil, or a synthetic oil is the continuous phase.

In deep-water drilling environments, it is important to control the rheological properties of invert emulsion drilling fluids at both low temperatures as well as at higher temperatures. Because of the extreme conditions during drilling, achieving an appropriate formulation for controlling or optimizing rheological properties of drilling fluids is challenging. It is often difficult to minimize the impact of temperature change on rheological properties.

The low temperatures in the deep-water environment cools down the drilling fluid, typically producing an increment in the fluid viscosity and gel strength. This higher viscosity and gel strength require higher pump pressures to initiate and maintain circulation, which translates into higher Equivalent Circulating Densities (“ECD”) downhole, and increased pressure surges. The increase in ECD could induce formation fractures, and consequent loss circulation problems. Many times, in offshore conditions, the fracture gradient and pore pressure window are so narrow that a minimal difference between Equivalent Static Density (ESD) and ECD, as well as minimal surge pressure, is imperative.

Another rheological challenge is the low shear the drilling fluid may experience at several sections of the well. There is a high risk of weight material/agent settling (i.e. barite sag) during low shear if the drilling fluid's rheological properties are not adequate to keep the weighting material/agent and drilled cuttings suspended, and to allow removal of cuttings for adequate hole cleaning.

To address these issues, additives for invert emulsion drilling fluids have been developed that include organophilic clays, emulsifiers, filtration control agents, and rheological modifiers together with the internal aqueous phase of the fluid to add optimal viscosity and suspension characteristics. Although some of these conventional formulations have demonstrated effectiveness, they have had a few drawbacks in offshore applications such as high temperature dependency resulting in high viscosity and high gel strength at low temperatures, but not enough yield point and low shear stress values at high temperatures.

Therefore, there is a need for improved formulations of drilling fluids for better control of rheological properties at a wide range of temperatures.

### SUMMARY

There is provided in one embodiment, a method for controlling and optimizing the rheological properties of drilling fluids in which an additive is introduced into an invert emulsion drilling fluid, the additive comprising: at least one organophilic clay, at least one weighting agent, at least on emulsifier, at least one filtration control agent, at least one polyamide resin, and at least one ethoxylated alcohol-based or an ether carboxylic acid-based rheology modifier. The resulting drilling fluid being used at a range of temperatures to perform various wellbore drilling and completion operations.

There is also provided a drilling fluid formulation suitable for controlling the rheological properties of invert emulsion drilling fluids that are used at a range of temperatures in operation, the formulation being made up of a base oil, at least one weighting agent, at least on emulsifier, at least one filtration control agent, at least one polyamide resin, and at least one ethoxylated alcohol-based or an ether carboxylic acid-based rheology modifier.

There is also provided, in another non-limiting embodiment, an additive composition comprising 1) at least one ethoxylated alcohol-based or an ether carboxylic acid-based rheology modifier, (2) at least one organophilic clay, (3) at least one weighting agent, (4) at least one filtration control agent, (4) at least one polyamide resin, and (5) at least one emulsifier.

### BRIEF DESCRIPTION OF THE DRAWINGS

FIG. 1 is a graph comparing the YP values and VSST results of various conventional invert emulsion drilling fluid formulations at 150° F. (“conventional system”) to the YP values and VSST results of various invert emulsion drilling fluid formulations of the kind disclosed herein at 150° F. (“novel system”).

FIG. 2 is a graph comparing the shear stress values at 40° F. and 150° F. of various conventional invert emulsion drilling fluid formulations (“conventional”) to the shear stress values at 40° F. and 150° F. of various invert emulsion drilling fluid formulations of the kind disclosed herein (“novel”).

### DETAILED DESCRIPTION

It has been discovered that an additive comprising either an ethoxylated alcohol-based or an ether carboxylic acid-based rheology modifier in combination with other components may be introduced to invert emulsion drilling fluids to create an invert drilling fluid formulation that has improved rheological properties and minimized weight material sag leading to reduced ECD.

More specifically, it has been discovered that such an additive may be used to reduce plastic viscosity, yield point, gel strength, and the viscometer sag shoe test value and maintain stability of invert emulsion drilling fluids at temperatures ranging from about 40° F. to about 300° F. Drilling fluids with low rheological property values, more stability, and better suspension capability (i.e. low weighting material/agent sag) can be operated with reduced pump pressures and less annular pressure loss.

The additive herein comprises, among other things: (1) at least one ethoxylated alcohol-based or an ether carboxylic acid-based rheology modifier, (2) at least one organophilic clay, (3) at least one weighting agent, (4) at least one filtration control agent, (4) at least one polyamide resin, and (5) at least one emulsifier.

In one embodiment, it may be added to an invert emulsion drilling fluid having a base oil that is soybean oil, mineral oil, and/or a synthetic oil. The additive may also be introduced to a drill-in fluid, a specialty fluid designed exclusively for drilling through the reservoir section of a wellbore.

The invert emulsion drilling fluid or drill-in fluid to which the additive is introduced may have an oil to water ratio ranging from 60:40 to 95:5 and a density ranging from about 9 pounds per gallon (“ppg”) to about 18 ppg.

The ethoxylated alcohol-based rheology modifier is a non-ionic surfactant with 2 to 5 ethylene oxide and a saturated or unsaturated, linear or branched alcohol having about 10 to 20 carbon atoms. Suitable ethoxylated alcohol-based rheology modifiers may be, without limitation, ethoxylated tridecyl alcohol, ethoxylated lauryl alcohol, alkoxylated fatty alcohols, ethoxylated laureate alcohol, ethoxylated oleth alcohol, and/or ethoxylated stearate alcohol.

The ether carboxylic acid-based rheology modifier may be an ether monocarboxylic acid, an ether dicarboxylic acid, and/or an ether tricarboxylic acid.

A polyamide resin is also used as a rheology modifier in the additive. The polyamide resin may be a dimer acid-based polyamide resin, a reaction product of di- tri or polyamine with an acid containing at least two carboxyl functional group example monocycle dimer diamine, acyclic dimer diamine. Preferably, the dimer fatty acid has 36 carbon atoms. The polyamines may be ethylenediamine, diethylenetriamine, triethylenetetramine, tetraethylenepentamine, and combinations thereof.

Materials that may be used for the weighting agent include, but are not necessarily limited to, any of the variety of materials known in the art for this purpose such barium sulfate, calcium carbonate, hematite, ilmenite, siderite and manganese tetraoxide, and/or dolomite. Particle size of the weighting agent may be around 90 microns for materials such as dolomite, and about 30 to 40 microns for materials such as barite. Use of a combination of materials here may be specified at times as well. The key here is that these materials have very limited solubility in water or oil, and they are present in enough concentration so as to be to some extent suspended solids in the fluid in question. The designation barium sulfate is taken to include the chemical species as well as the mineral form, barite, and similarly for calcium carbonate and calcite.

Suitable organophilic clays for use in the additive and formulation disclosed herein are, without limitation, bentonite, hectorite, and/or attapulgite. These organophilic clays may be manufactured using a wet process and/or using alkyl quaternary ammonium compounds.

The additive also includes a filtration control agent. Examples of filtration control agents useful for this purpose are a pre-crosslinked substituted styrene acrylate, pliolite, a substituted styrene-acrylate copolymer, and/or a styrene block copolymer.

The emulsifier that is part of the additive may be based on an amine and/or tall oil derivative, such as, for example, imidazoline maleic anhydride fatty acid derivative and oxidized tall oil.

Optional components of the invert emulsion drilling fluid include, but are not necessarily limited to, lime and wetting agents.

The at least one rheology modifier is present in the drilling fluid in an amount ranging from about 0.5 to about 18 pounds per barrel of the drilling fluid (“ppb”), more preferably from about 0.5 to about 10 ppb. The base oil is present in an amount ranging from about 150 to about 250 ppb. The at least one organophilic clay is present in amount ranging from about 1 ppb to about 6 ppb. The at least one weighting agent is present in amount ranging from about 50 ppb to about 500 ppb. The at least one filtration control agent is present in amount ranging from about 0.5 to about 4 ppb. The at least one polyamide resin is present in amount ranging from about 0.5 to about 4 ppb. The at least one emulsifier is present in amount ranging from about 7 to about 16 ppb, and alternatively, from about 8 to 12 ppb.

The additive may be blended with the drilling fluid or the drill-in fluid at the drilling fluid/mud plant or at the drilling rig.

Once the additive is introduced to the drilling fluid or drill-in fluid, the resulting fluid may be used to perform the following operations: drilling a wellbore; completing a well; remediating a subterranean formation, other than by acidizing; stimulating a subterranean formation; fracturing a subterranean formation; and combinations thereof.

The invention will be further described with respect to the following Examples, which are not meant to limit the invention, but rather to further illustrate the various embodiments.

### Examples

Several invert drilling fluid formulations were prepared incorporating additives of the kind disclosed herein.

Samples of 12.0 pounds per gallon (“ppg”) formulations having a 75:25 oil to water ratio were evaluated to understand the impact of the use of the additive on the rheological properties of the drilling fluid and to see if they achieved the desired or acceptable standards for performance for drilling fluids.

The composition and make up of sample formulations prepared with the additives of the kind disclosed herein are outlined in Tables 1 and 2.

All samples were dynamically aged or hot rolled at 250° F. for 16 hours. After that, the samples were subjected to following tests: rheology (plastic viscosity (“PV”), yield point (“YP”), Low Shear Yield Point (“LSYP”), and gel), high temperature, high pressure (“HPHT”) filtration, and static and dynamic sag. Rheological property evaluations were conducted at three temperatures (40° F., 120° F., and 150° F.). For the high temperature testing (at 150° F., at 250° F., or at 300° F.), samples were tested under pressure conditions sufficient to avoid evaporation and simulate bottom hole conditions.

Electrical Stability (“ES”) tests, which indict the emulsion and oil-wetting qualities of a sample, and Viscometer Sag Shoe Tests (“VSST”) to determine level of sag were run at 150° F. HPHT filtrate testing was run at 250° F. after aging.

All of the testing procedures followed the API Recommended Practice 13B-25^{th} edition: Recommended Practice for Field Testing Oil-based Drilling Fluids.

As the test results in Tables 4-7 demonstrate, as compared to conventional drilling fluid formulation, the formulations incorporating the additives of the kind disclosed herein (“novel”) have significant lower viscosity (PV, YP, and gel strength) than conventional system at low (e.g. 40° F.) and at high temperature (e.g. 150° F. or 250° F.). Better performance is also observed with the HPHT viscosity testing (Tables 6 and 7) when a conventional formulation is compared to fluid formulation having the kind of additives disclosed herein. The viscosity vs. temperature profile is maintained uniformly from about 40° F. to about 250° F., according to Table 6. Table 7 shows performance of a conventional drilling fluid under similar temperature conditions.

These novel fluid sample formulations demonstrated a minimal difference in YP throughout range of pressure (from about 0 psi to about 20,000 psi) and temperature (from about 40° F. to about 250° F., as well as 6 and 3 readings, showing a minimal temperature impact on rheological properties. The results for a conventional drilling fluid shows considerable change in YP and 6 and 3 readings throughout tested pressure and temperature ranges and shows high viscosity in comparison with novel formulations. Also, the novel formulations exhibit fragile gel strength throughout range of temperature 40° F. to 150° F. and significantly low VSST values: less than 1 ppb at a temperature of 150° F.

Overall, the novel formulations show a low viscosity profile at low and high temperatures (i.e. a minimal temperature impact), and at same time present optimum suspension capability and minimum VSST. The conventional drilling fluid formulations did not demonstrate the same good performance.

In addition, samples of novel formulations were stable up to 300° F. after roll over for 16 h (conducted pursuant to API Recommended Practice).

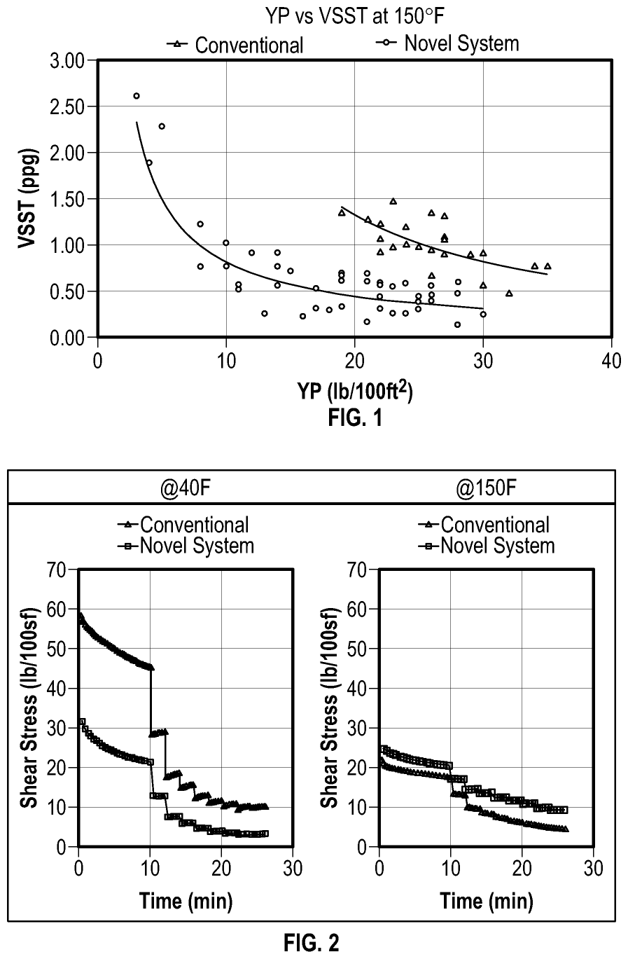

FIG. 1 shows that the fluids containing the additives disclosed herein have a lower VSST value. VSST values reflect suspension capability under dynamic conditions. The lower is the VSST value, the better the suspension capability. FIG. 1 also shows that while the conventional drilling fluid formulations that were evaluated had to increase their rheological behavior at high temperatures to be able to suspend weighting material, the formulations made up of the additives of the kind disclosed herein demonstrated optimum suspension capability without sacrificing optimum rheological behavior.

FIG. 2 displays the shear stress levels at 40° F. and 150° F. of various conventional invert emulsion drilling fluid formulations (“conventional”) to the shear stress values at 40° F. and 150° F. of various invert emulsion drilling fluid formulations of the kind disclosed herein (“novel”).

All concentrations shown are in ppb (pounds per barrel). A lab equivalent barrel is 350 mL.

TABLE 1
Generic names for formulation components

| | | | Concen- |
|---|---|---|---|
| | | | tration |
| Function | Description | Name | (ppb) |
| Base oil | Synthetic olefin | GT-3000 | As needed |
| Emulsifiers | Imidazoline | DFE-4082 | 8-14 |
| | maleic acid | | |
| | Oxidized tall oil | DFE-416 | 1-2 |
| Alkalinity/Activator | Calcium Oxide | MIL-LIME | 2-4 |
| Emulsion Stabilizer | Bentonite | DFE-4030 | 1-6 |
| | Organophilic clay | | |
| Internal phase | Brine | 15-30% CaCl2 | As needed |
| | | Brine | |
| Filtration controller | Substituted styrene | DFE-1708 | 0.5-4 |
| | acrylate copolymer | | |
| Weighting agent | Barite | DFE-4053 | As needed |
| Rheology modifiers | Polyamide resin | DFE-4073 | 0.5-4 |
| | Alcohol Derivative | DFE-4081 | 0.5-4 |

TABLE 2
12.0 ppg 75:25 OWR Formulations for
Novel Additive and Drilling Fluid

| | | | Concen- |
|---|---|---|---|
| | | | tration |
| Function | Component | | (ppb) |
| Base oil | Synthetic oil | BASE OIL | 158.8 |
| | Amine derivate | EMULSIFIER 1 | 8-14 |
| | Amine derivate | EMULSIFIER 2 | 1-2 |
| Alkalinity/emulsifier | | MIL-LIME | 2-4 |
| activator | | | |
| Emulsion Stabilizer | Organophilic clay | DFE-4030 | 1-3 |
| Internal phase | Brine | 25% CaCl₂ Brine | 94.3 |
| Filtration controller | Polymer | DFE-1708 | 0.5-3 |
| Weighting agent | Barite | DFE-4053 | 231.4 |
| Rheology modifiers | Derivative | DFE-4078, DFE-4077, | 0.5-18 |
| | alcohol | DFE-4081 | |
| | Ether | DFE-4079 | 0.5-18 |
| | carboxylic acid | | |
| | Polyamide resin | DFE-4073 | 0.5-4 |

TABLE 3
Conventional drilling fluid typical
formulation 12.0 ppg 75:25 OWR

| | | Concentration |
|---|---|---|
| | | (lb/bbl) |
| GT-3000 | Based synthetic olefin | 158.8 |
| OMNIMUL 2 | Emulsifier | 12 |
| MIL-LIME | Alkalinity | 4 |
| RHEOCLAY plus | Organophilic clay | 2 |
| 25% CaCl2 Brine | Internal phase | 94.3 |
| BIO-COTE | Dispersant | 0.25 |
| MAGMATROL | Filtration control agent | 2 |
| MIL-BAR | Weighting material | 229.84 |
| RHEOLINE HT | Rheology modifier | 1.0 |

TABLE 4
Rheology Modifier DFE-4073 (Polyamide Resin) concentration
impact on 12 ppg 75:25 OWR Sample

| | 1 | 2 |
|---|---|---|
| OIL BASE | 158.8 | 158.8 |
| EMULSIFIER | 10 | 10 |
| SECUNDARY | 1 | 1 |
| EMULSIFIER | | |
| ORGANOPHILIC | 3 | 3 |
| CLAY | | |
| RHEOLOGICAL | 0 | 1.5 |
| MODIFIER | | |

Post Hot Roll @ 250° F.

| Rheology/Temp | 40 | 120 | 150 | 40 | 120 | 150 |
|---|---|---|---|---|---|---|
| 600 rpm | 148 | 43 | 33 | 134 | 56 | 48 |
| 300 rpm | 85 | 24 | 19 | 76 | 36 | 32 |
| 200 rpm | 63 | 18 | 14 | 55 | 29 | 26 |
| 100 rpm | 39 | 11 | 9 | 32 | 21 | 19 |
| 6 rpm | 11 | 3 | 2 | 8 | 10 | 10 |
| 3 rpm | 10 | 3 | 2 | 7 | 10 | 9 |
| PV (cP) | 36 | 19 | 14 | 58 | 20 | 16 |
| YP (lb/100 ft²) | 22 | 5 | 5 | 18 | 16 | 16 |
| LSYP (lb/100 ft²) | 19 | 3 | 2 | 6 | 10 | 8 |
| 10 Sec gels (lb/100 ft²) | 10 | 4 | 3 | 11 | 12 | 11 |
| 10 min gels (lb/100 ft²) | 14 | 4 | 3 | 23 | 19 | 16 |
| 30 min gels (lb/100 ft²) | 15 | 4 | 3 | 27 | 21 | 17 |
| ES (V) | | 438 | 438 | | 525 | 510 |
| HPHT @ 250° F. | | | 3.8 | | | 2.2 |

VSST

| | | |
|---|---|---|
| VSST (ppg) | 2.83 | 0.34 |

TABLE 5
Rheology Modifiers Comparison in Samples having OWR 75:25 and Density 12 ppg

| | Conventional fluids | 2 | 3 | 4 |
|---|---|---|---|---|
| DFE-4077 | | — | 1 | — |
| DFE-4078 | | — | — | 1.5 |
| DFE-4079 | | — | — | |
| DFE-4081 | | — | — | |

Post Hot Roll @ 250° F.

| Rheology/Temperature | 40 | 120 | 150 | 40 | 120 | 150 | 40 | 120 | 150 | 40 |
|---|---|---|---|---|---|---|---|---|---|---|
| 600 rpm | 171 | 74 | 63 | 134 | 56 | 48 | 121 | 54 | 45 | 117 |
| 300 rpm | 105 | 46 | 43 | 76 | 36 | 32 | 67 | 32 | 28 | 64 |
| 200 rpm | 79 | 35 | 32 | 55 | 29 | 26 | 48 | 25 | 23 | 45 |
| 100 rpm | 52 | 25 | 24 | 32 | 21 | 19 | 27 | 17 | 16 | 26 |
| 6 rpm | 23 | 13 | 14 | 8 | 10 | 10 | 6 | 7 | 7 | 7 |
| 3 rpm | 22 | 13 | 13 | 7 | 10 | 9 | 5 | 6 | 7 | 6 |
| PV (cP) | 66 | 28 | 20 | 58 | 20 | 16 | 54 | 22 | 17 | 53 |
| YP (lb/100 ft²) | 39 | 18 | 23 | 18 | 16 | 16 | 13 | 10 | 11 | 11 |
| LSYP (lb/100 ft²) | 21 | 13 | 12 | 6 | 10 | 8 | 4 | 5 | 7 | 5 |
| 10 Sec gels (lb/100 ft²) | 22 | 17 | 16 | 11 | 12 | 11 | 6 | 8 | 8 | 7 |
| 10 min gels (lb/100 ft²) | 44 | 24 | 20 | 23 | 19 | 16 | 15 | 13 | 12 | 18 |
| 30 min gels (lb/100 ft²) | 45 | 25 | 21 | 27 | 21 | 17 | 18 | 15 | 13 | 22 |
| 10 min/10 sec | 2.0 | 1.4 | 1.3 | 2.1 | 1.6 | 1.5 | 2.5 | 1.6 | 1.5 | 2.6 |
| 30 min/10 min | 1.0 | 1.0 | 1.1 | 1.2 | 1.1 | 1.1 | 1.2 | 1.2 | 1.1 | 1.2 |
| ES (V) | | | 804 | | | 600 | | | 510 | |
| HPHT @ 250° F. | | | | | | 3.2 | | | | |

Rheology comparison

| | | | |
|---|---|---|---|
| PV ratio 40/120° F. | 2.4 | 2.9 | 2.5 |
| 10 sec gels 40/120° F. | 23% | −9% | −33% |
| 10 min gels 40/120° F. | 45% | 17% | 13% |
| 30 min gels 40/120° F. | 44% | 22% | 17% |

VSST

| | | | |
|---|---|---|---|
| w1 (ppg) | 12.32 | 12.00 | 12.00 |
| w2 (ppg) | 13.53 | 12.47 | 12.57 |
| VSST (ppg) | 1.21 | 0.47 | 0.57 |

| | 4 | | 5 | | | 6 | | |
|---|---|---|---|---|---|---|---|---|
| DFE-4077 | — | | | | | | | |
| DFE-4078 | 1.5 | | | | | | | |
| DFE-4079 | | | 1 | | | | | |
| DFE-4081 | | | | | | 1.5 | | |
| Post Hot Roll @ 250° F. | | | | | | | | |
| Rheology/Temperature | 120 | 150 | 40 | 120 | 150 | 40 | 120 | 150 |
| 600 rpm | 59 | 49 | 126 | 53 | 47 | 120 | 61 | 53 |
| 300 rpm | 37 | 33 | 70 | 33 | 31 | 68 | 40 | 36 |
| 200 rpm | 30 | 26 | 50 | 26 | 25 | 49 | 32 | 29 |
| 100 rpm | 21 | 20 | 29 | 18 | 18 | 30 | 23 | 21 |
| 6 rpm | 11 | 10 | 7 | 8 | 8 | 12 | 12 | 11 |
| 3 rpm | 10 | 10 | 6 | 8 | 7 | 12 | 11 | 11 |
| PV (cP) | 22 | 16 | 56 | 20 | 16 | 52 | 21 | 17 |
| YP (lb/100 ft²) | 15 | 17 | 14 | 13 | 15 | 16 | 19 | 19 |
| LSYP (lb/100 ft²) | 9 | 10 | 5 | 8 | 6 | 12 | 10 | 11 |
| 10 Sec gels (lb/100 ft²) | 13 | 12 | 8 | 9 | 9 | 15 | 14 | 13 |
| 10 min gels (lb/100 ft²) | 21 | 17 | 17 | 16 | 12 | 25 | 21 | 18 |
| 30 min gels (lb/100 ft²) | 23 | 18 | 19 | 17 | 14 | 25 | 23 | 18 |
| 10 min/10 sec | 1.6 | 1.4 | 2.1 | 1.8 | 1.3 | 1.7 | 1.5 | 1.4 |
| 30 min/10 min | 1.1 | 1.1 | 1.1 | 1.1 | 1.2 | 1.0 | 1.1 | 1.0 |
| ES (V) | | 590 | | | 402 | | | 435 |
| HPHT @ 250° F. | | 2.3 | | | | | | 1.6 |
| Rheology comparison | | | | | | | | |
| PV ratio 40/120° F. | 2.4 | | | 2.8 | | | 2.5 | |
| 10 sec gels 40/120° F. | −86% | | | −13% | | | 7% | |
| 10 min gels 40/120° F. | −17% | | | 6% | | | 16% | |
| 30 min gels 40/120° F. | −5% | | | 11% | | | 8% | |
| VSST | | | | | | | | |
| w1 (ppg) | | 12.00 | | | 12.00 | | | 12.00 |
| w2 (ppg) | | 12.31 | | | 12.71 | | | 12.41 |
| VSST (ppg) | | 0.31 | | | 0.71 | | | 0.41 |

TABLE 6
HPHT Viscosity for a formulation containing additives
of the kind disclosed herein (“novel”)

| Temp | Pressure | | | | | | | | |
|---|---|---|---|---|---|---|---|---|---|
| (° F.) | (psi) | 600 | 300 | 200 | 100 | 6 | 3 | PV | YP |
| 40 | 15 | 113 | 66 | 48 | 30 | 11 | 10 | 47 | 19 |
| 40 | 2000 | 142 | 77 | 57 | 36 | 12 | 11 | 66 | 11 |
| 40 | 4000 | 168 | 91 | 66 | 42 | 13 | 11 | 77 | 14 |
| 80 | 15 | 67 | 40 | 31 | 21 | 9 | 9 | 27 | 14 |
| 80 | 4000 | 91 | 55 | 41 | 27 | 11 | 10 | 37 | 18 |
| 120 | 15 | 55 | 37 | 31 | 24 | 13 | 13 | 17 | 20 |
| 120 | 7000 | 81 | 52 | 42 | 31 | 16 | 16 | 29 | 23 |
| 150 | 15 | 49 | 34 | 29 | 22 | 13 | 12 | 15 | 19 |
| 150 | 10000 | 82 | 56 | 46 | 35 | 18 | 17 | 27 | 29 |
| 220 | 15000 | 73 | 50 | 42 | 32 | 17 | 15 | 23 | 27 |
| 250 | 20000 | 75 | 50 | 42 | 31 | 16 | 14 | 25 | 26 |

TABLE 7
HPHT Viscosity for a conventional formuation

| Temp | Pressure | | | | | | | | |
|---|---|---|---|---|---|---|---|---|---|
| (° F.) | (psi) | 600 | 300 | 200 | 100 | 6 | 3 | PV | YP |
| 40 | 15 | 176 | 108 | 87 | 59 | 26 | 24 | 68 | 40 |
| 40 | 2000 | 218 | 142 | 113 | 78 | 33 | 30 | 76 | 66 |
| 40 | 4000 | 244 | 161 | 129 | 89 | 39 | 36 | 83 | 78 |
| 80 | 15 | 97 | 61 | 50 | 35 | 19 | 17 | 36 | 25 |
| 80 | 4000 | 128 | 81 | 64 | 44 | 22 | 21 | 47 | 34 |
| 120 | 15 | 67 | 44 | 35 | 26 | 15 | 4 | 23 | 21 |
| 120 | 7000 | 98 | 62 | 52 | 37 | 20 | 18 | 36 | 26 |
| 150 | 15 | 58 | 40 | 33 | 25 | 15 | 14 | 18 | 22 |
| 150 | 10000 | 93 | 62 | 52 | 38 | 21 | 19 | 31 | 31 |
| 220 | 15000 | 90 | 64 | 55 | 42 | 22 | 18 | 26 | 38 |
| 250 | 20000 | 93 | 68 | 58 | 47 | 24 | 20 | 25 | 43 |

In the foregoing specification, the invention has been described with reference to specific embodiments thereof, and has been suggested as effective in providing methods, additives, and formulations for improving the performance and properties of drilling fluids and drill-in fluids. However, it will be evident that various modifications and changes can be made there to without departing from the broader scope of the invention as set forth in the appended claims. Accordingly, the specification is to be regarded in an illustrative rather than a restrictive sense. For example, organophilic clays, weighting agents, filtration control agents, polyamide resins, emulsifiers, ethoxylated alcohol-based or ether carboxylic acid-based rheology modifiers, fluids, ratios, fluid conditions, and the like falling within the claimed parameters, but not specifically identified or tried, are expected to be within the scope of this invention.

The present invention may suitably comprise, consist of or consist essentially of the elements disclosed and may be practiced in the absence of an element not disclosed. For instance, the additive for introducing to an inverted emulsion drilling fluid may comprise, consist essentially of, or consist of at least one organophilic clay, at least one weighting agent, at least one emulsifier, at least one filtration control agent, at least one polyamide resin, and at least one ethoxylated alcohol-based or an ether carboxylic acid-based rheology modifier. Further, the drilling fluid formulation may comprise, consist essentially of, or consist of a base oil, at least one organophilic clay, at least one weighting agent, at least one emulsifier, at least one filtration control agent, at least one polyamide resin, and at least one ethoxylated alcohol-based or an ether carboxylic acid-based rheology modifier.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

To the extent used herein, the singular forms “a,” “an,” and “the” are intended to include the plural forms as well, unless the context clearly indicates otherwise.

To the extent used herein, the term “about” in reference to a given parameter is inclusive of the stated value and has the meaning dictated by the context (e.g., it includes the degree of error associated with measurement of the given parameter).

To the extent used herein, the term “and/or” includes any and all combinations of one or more of the associated listed items.

To the extent used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

The words “comprising” and “comprises” as used throughout the claims is to interpreted “including but not limited to”.

What is claimed is:

1. A method for controlling and optimizing the rheological properties of drilling fluids comprising:
introducing an additive into an invert emulsion drilling fluid, the additive comprising:
(1) at least one organophilic clay,
(2) at least one weighting agent,
(3) at least one emulsifier,
(4) at least one filtration control agent,
(5) at least one polyamide resin, and
(6) at least one ethoxylated alcohol-based rheology modifier.

2. The method of claim 1 wherein after the additive is introduced into the invert emulsion drilling fluid, the method further comprising performing a procedure selected from the group consisting of:
drilling a wellbore;
completing a well;
remediating a subterranean formation, other than by acidizing;
stimulating a subterranean formation;
fracturing a subterranean formation; and
combinations thereof.

3. The method of claim 1 wherein the invert emulsion drilling fluid has an oil to water ratio of about 60:40 to about 95:5.

4. The method of claim 1 wherein the at least one weighting agent is selected from the group consisting of barium sulfate, calcium carbonate, hematite, ilmenite, siderite, manganese tetraoxide, dolomite, and combinations thereof.

5. The method of claim 1 wherein the temperature of the invert emulsion drilling fluid ranges from about 40° F. to about 300° F.

6. The method of claim 1 wherein the at least one ethoxylated alcohol-based rheology modifier is present an amount ranging from about 0.5 ppb to about 18 ppb based on the total amount of the invert emulsion drilling fluid.

7. A method for controlling and optimizing the rheological properties of drilling fluids comprising:
introducing an additive into an invert emulsion drilling fluid, the additive comprising:
(1) at least one organophilic clay,
(2) at least one weighting agent,
(3) at least one filtration control agent,
(4) at least one emulsifier,
(5) at least one polyamide resin, and
(6) at least one ether carboxylic acid-based rheology modifier.

8. The method of claim 7 wherein after the additive is introduced into the invert emulsion drilling fluid, the method further comprising performing a procedure selected from the group consisting of:
drilling a wellbore;
completing a well;
remediating a subterranean formation, other than by acidizing;
stimulating a subterranean formation;
fracturing a subterranean formation; and
combinations thereof.

9. The method of claim 7 wherein the invert emulsion drilling fluid has an oil to water ratio of about 60:40 to about 95:5.

10. The method of claim 7 wherein the weighting agent is selected from the group consisting of barium sulfate, calcium carbonate, hematite, ilmenite, siderite, manganese tetraoxide, dolomite and combinations thereof.

11. The method of claim 7 wherein the temperature of the invert emulsion drilling fluid ranges from about 40° F. to about 300° F.

12. The method of claim 7 wherein the ether carboxylic-based rheology modifier is present an amount ranging from about 0.5 ppb to about 18 ppb based on the total amount of the invert emulsion drilling fluid.

13. A drilling fluid formulation comprising:
(1) a base oil,
(2) at least one emulsifier
(3) at least one organophilic clay,
(4) at least one weighting agent,
(5) at least one filtration control agent,
(6) at least one polyamide resin, and
(7) at least one rheology modifier, and
wherein the drilling fluid formulation is an invert emulsion drilling fluid formulation.

14. The drilling fluid formulation of claim 13 wherein the at least one base oil is selected from a group consisting of a synthetic oil, a mineral oil, soybean oil, and combinations thereof.

15. The drilling fluid formulation of claim 13 wherein the at least one organophilic clay is selected from a group consisting of bentonite, hectorite, attapulgite, and combinations thereof.

16. The drilling fluid of claim 13 the at least one weighting agent is selected from the group consisting of barium sulfate, calcium carbonate, hematite, ilmenite, siderite, manganese tetraoxide, dolomite, and combinations thereof.

17. The drilling fluid formulation of claim 13 wherein the at least one filtration control agent is selected from a group consisting of a styrene acrylate, pliolite, a substituted styrene-acrylate copolymer, a styrene block copolymer, and combinations thereof.

18. The drilling fluid formulation of claim 13 wherein the at least one rheology modifier is ethoxylated alcohol-based or ether carboxylic acid-based.

19. The drilling fluid formulation of claim 18 wherein the at least one rheology modifier is an ethoxylated alcohol-based rheology modifier selected from a group consisting of ethoxylated tridecyl alcohol, ethoxylated lauryl alcohol, alkoxylated fatty alcohols, ethoxylated laureate alcohol, ethoxylated oleth alcohol, ethoxylated stearate alcohol, and combinations.

20. The drilling fluid formulation of claim 18 wherein the at least one rheology modifier is an ether carboxylic acid-based rheology modifier selected from a group consisting of monocarboxylic acid, an ether dicarboxylic acid, an ether tricarboxylic acid, and combinations thereof.

21. The drilling fluid formulation of claim 13 where:
(1) the base oil ranges from about 150 ppb to about 250 ppb,
(2) the at least one organophilic clay ranges from about 1 ppb to about 6 ppb,
(3) the at least one weighting agent ranges from about 50 ppb to about 500 ppb,
(4) the at least one filtration control agent ranges from about 0.5 to about 4 ppb,
(5) the at least one polyamide resin ranges from about 0.5 to about 4 ppb,
(6) the at least one emulsifier ranges from about 7 ppb to about 16 ppb, and
(7) the at least one rheology modifier ranges from about 0.5 to about 18 ppb.

22. An additive for an invert emulsion drilling fluid, the additive comprising:
(1) at least one organophilic clay,
(2) at least one emulsifier,
(3) at least one weighting agent,
(4) at least one filtration control agent,
(5) at least one polyamide resin, and
(6) at least one ethoxylated alcohol-based rheology modifier.
